(19) United States
(12) Patent Application Publication
(10) Pub. No.: US 2012/0232186 A1
(43) Pub. Date: Sep. 13, 2012

(54) RUBBER COMPOSITION AND PNEUMATIC TIRE

(75) Inventor: Shinsaku Kamada, Osaka (JP)

(73) Assignee: TOYO TIRE & RUBBER CO., LTD., Osaka (JP)

(21) Appl. No.: 13/364,507

(22) Filed: Feb. 2, 2012

(30) Foreign Application Priority Data
Mar. 7, 2011 (JP) 2011-049418

(51) Int. Cl. C08L 19/00; C08L 97/02

(52) U.S. Cl. 523/157; 523/152

(57) ABSTRACT

A rubber composition for tire comprises: diene rubber component consisting of diene rubber (s); and multihollow particles amounting 0.3-20 mass parts relative to 100 mass parts of the diene rubber component; and microvoids being distributed in each of the multihollow particles throughout from a vicinity of center portion to a vicinity of surface of the particle; and porosity of the multihollow particles being in a range of 40% to 60%. A pneumatic tire has a tread that is formed of such rubber composition.

### BACKGROUND OF THE INVENTION

The present invention relates to a rubber composition and, in more particular, to a rubber composition that is preferably adoptable in forming a tread part of a winter tire such as studless tire and snow tire, as well as pneumatic tire obtainable by use of such rubber composition.

On snow-covered or ice-covered road, friction coefficient between tire tread and road face is remarkably decreased from that on normal road without snow or ice. Thus, in the rubber composition for the tread part of the winter tire such as the studless tire, hardness of rubber at low temperature has been kept to be low by adopting butadiene rubber or the like having a low glass transition temperature or by including a rubber softener, in order to improve contacting between the tread part and the road face. Meanwhile, in order to increase the friction coefficient, there have been made adopting of foamed rubber in the tread part, as well as adding of hard particles or fibers such as hollow particles, glass fiber strands and lignocellulosic or cellulosic powder.

For example, JP1997 (H10)-007841A (Japan patent application publication No. H10-007841) proposes adding of particles, which have scratching effect, such as lignocellulosic or cellulosic materials obtained by pulverizing of seed shells or fruit pits or the like, so as to improve friction on ice by way of the scratching effect. The JP1997 (H10)-007841A particularly proposes applying a rubber-to-particle adhesion promoter, which is mainly comprised of mixture of resorcinol-formaldehyde resin prepolymer and latex (resorcinol-formaldehyde latex, i.e. RFL), on surfaces of the particles so as to cause chemical bonding between the surfaces of the particles and rubber of the tread part, and thereby improve the scratching effect. It is additionally described, as a mechanism for improving friction on ice, that “the particles are protruded from surface of the tread at a time the particles are contacted with road face” so as to “destroy thin-wall portions” (of ice covering the road face, which is derived from compressed snow).

JP2001-123017A proposes adding of fraipontite-silica composite, in which each unit layer of fine lamina-form fraipontite crystal of metal aminosilicate is held around a silica particle, into rubber component, in order to efficiently remove water film on a surface of the ice. Meanwhile, JP2005-162865A proposes adding of pulverized bamboo charcoal or the like, which has average particle diameter in a range of 10 μm to 500 μm, into the rubber composition, in order to further efficiently remove water film on a surface of the ice.

JP2002-201306A and JP2001-139719A propose adding of heat-expandable hollow polymer particles into a master batch for producing tires, in order to improve performances on the ice-covered road face. The heat-expandable hollow polymer particles are microcapsules, in which low-boiling point hydrocarbons in liquid form is encapsulated by thermoplastic polymer shell. Presumably, these polymer particles are expanded by heating on course of preparing the master batch so as to form thin-wall balloons, which facilitate removing of water film on tread surface that is being abraded. The JP2001-139719A discloses that surfaces of the heat-expandable hollow polymer particles are treated on before hand, with liquid diene polymer, or with the resorcinol-formaldehyde latex (RFL), which is a mixture of resorcinol-formaldehyde resin prepolymer and latex, so as to improve processability of the rubber composition.

Each of hereto-mentioned conventional methods makes improving of performances of the tire on the ice-covered road face. Nevertheless, such improvement is not necessarily in a sufficient level vis-à-vis market demand that is ever becoming stricter.

Meanwhile, JP2005-146223A discloses a method of manufacturing spherical porous particles that has high porosity and high strength, from cross-linking acrylate monomers. Thus obtained particles are considered to be preferably applicable in use for delustering and/or sintering.

In view of the above, it is aimed to provide a rubber composition and a pneumatic tire, which enables to further improve the braking performance on ice-covering road.

### BRIEF SUMMARY OF THE INVENTION

In course of earnest investigation in view of the above and of trying to add various materials into the rubber composition, the inventor has happened to add spherical multihollow particles, each of which has a number of fine pores at inside of the particle, into a rubber composition for the tread part of the studless tire. Resultantly, it has been found that, when the multihollow microparticles having certain level of particle diameters and certain microstructures are used, both of the scratching effect and water-film removing effect are achieved so that braking performance on ice-covered road is remarkably improved. The multihollow microparticles having been adopted here, in particular, are constructed as follows: in each of the particles, microvoids or fine cavities are distributed from core to a vicinity of surface in all directions, substantially with no directionality, so that no stress concentration is made within the particle and hence, high porosity and high strength are achieved. Thus, the construction within the above particle is strikingly different from that of the bamboo charcoal and from that of spherical shell-shaped hollow polymer particles having only one cavity in each particle.

According to preferred embodiment of the invention, a rubber composition for a pneumatic tire comprises: a diene rubber component consisting of diene rubber polymer(s); and multihollow particles amounting 0.3-20 mass parts relative to 100 mass parts of the diene rubber component; and a number of microvoids being distributed in each of the multihollow particles throughout from a vicinity of center portion to a vicinity of surface of the particle in all directions, with substantially no directionality; and porosity of the multihollow particles being in a range of 40% to 60%. A pneumatic tire according to the invention is that having a tread part formed of the above rubber composition.

### BRIEF DESCRIPTION OF THE DRAWINGS

FIG. 1 is an electron micrograph of the rubber composition of an Example as observed after kneader-mixing; and

FIG. 2 is an electron micrograph of the rubber composition of a Comparative example as observed after kneader-mixing in a same manner as the above.

### DETAILED DESCRIPTION OF THE INVENTION

According to the embodiments of the invention, performances on ice-covered road face is remarkably increased while deterioration of wear resistance is curbed.

Hereafter, preferred embodiments of the invention are described in detail.

As the diene rubber component in the rubber composition according to the invention, any of various diene rubbers that are usually used in the rubber composition for tire tread may be adopted. Examples of adoptable diene rubbers are: natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber, to name a few. Only one of such diene rubbers or two or more of such diene rubbers as a rubber blend may be adopted as the rubber component.

Preferably, a rubber blend of the natural rubber and the other diene rubber is used for the rubber component. Especially preferred is a rubber blend of the natural rubber and the butadiene rubber. Mass ratio of the natural rubber (NR) to the butadiene rubber (BR) is preferably in a range of 30/70 to 80/20, more preferably in a range of about 40/60 to 70/30. This is because: when ratio of the butadiene rubber (BR) is too small, low-temperature performance of the rubber composition would become insufficient; and when ratio of the butadiene rubber (BR) is too large, processability of the rubber composition and tear-resistance performance would tend to be deteriorated.

The rubber composition according to embodiments of the invention comprises multihollow particles, each of which has numerous fine microvoids at inside of the particle, and which are added to the diene rubber component. In the multihollow particles according to preferred embodiments, numerous fine microvoids are substantially uniformly distributed throughout from a vicinity of center portion to a vicinity of a surface in all directions, in the particle so as to achieve a porosity of the particles in a range of 40% to 60%. The porosity is preferably in a range of 45% to 55% in view of balancing between easiness of producing and achievable performances. By such fine structure of the particle, high particle strength is achieved along with high porosity. Thus, the microvoids would not be collapsed or flattened by way of deformation of the particles on course of kneader-mixing of the rubber composition. The multihollow particles according to preferred embodiments of the invention have compressive resistance strength no less than 15 Mpa and preferably no less than 20 Mpa, when the compressive resistance strength is calculated as converted to that of 50% porosity. The compressive resistance strength means a stress actually needed in crushing a particle on course of applying a load onto the particle. The compressive resistance strength may be measured by using “Shimadzu MCT-W Series micro-compression testers” for example and by adopting: for example, 500 μm diameter flat indenter or upper pressing plate, which is formed of diamond; and stainless-steel lower pressing plate, as well as loading rate of 7.1 mN/s. The porosity of the particles may be measured by using a “porosimeter 2000”, a product of AMCO Inc., at 196 MPa of mercury-intrusion pressure. According to preferred embodiments of the invention, when the multihollow particles are added by 5 mass parts into a rubber composition including 100 mass parts of the diene rubber components and 50 mass parts of fillers; storage modulus of elasticity of vulcanized rubber increases preferably by no less than 15% and more preferably by no less than 20%, compared to that obtained by not adding the multihollow particles. The multihollow particles included in the composition of the invention are preferably shaped as spherical or nearly spherical. By such shaping of the particles, fracturing and deforming of the particles on course of kneader mixing is further curbed.

The multihollow particles to be included in the composition of the invention may be efficiently produced by: adopting monomers that form resin having relatively high hardness and toughness; and forming a water-in-oil-in-water (W/O/W) emulsion, in which each oil phase consisting of the monomers includes minute water droplets and is dispersed in water. In liquid of the monomer, cross-linking monomers are included. When to prepare the water-in-oil-in-water (W/O/W) emulsion from the liquid of monomer, this is dispersed in water to form a water-in-oil (W/O) emulsion on first hand by using an emulsifier that has low HLB value (that is, lipophilic groups are dominant in the emulsifier compound); such as glycerin tristearate (HLB value=1.7), polyglycerin polyricinoleate (HLB value=0.3), sorbitan tristearate (HLB value=2.0) and sorbitan tribehenate (HLB value=1.5), for examples. Subsequently, the water-in-oil (W/O) emulsion is dispersed in aqueous solution of polyvinyl alcohol (PVA) for example. Thus, water-in-oil-in-water (W/O/W) emulsion is obtained; and then, the monomers are polymerized by heating under deoxygenized atmosphere, and thus obtained polymer is dehydrated and vacuum dried, so as to give the multihollow particles. Namely, the multihollow particles may be produced by a method in line with that disclosed in the above-mentioned JP2005-146223A, with some modifications if necessary.

As in the above, when to form spherical acrylic fine particles, the polymerization may be proceeded while maintaining a form or morphology of the water-in-oil emulsion. Then, numerous microvoids that are distributed throughout from core to surface part are easily formed in each of the particles. Thus, such particles are preferably used as the multihollow particles for the invention. The multihollow particles for the invention may be produced by other methods insofar as the particles have the prescribed porosity and a required level of particle strength as a result of uniform distribution of the numerous microvoids throughout from vicinity of center point to vicinity of surface. For example, such multihollow particles are presumably obtainable by following method: foaming agent that induces mild foaming at a time of polymerization is uniformly dispersed within each of the particles, and foaming is gradually proceeded on course of the polymerization.

Average particle diameter (to be occasionally referred as “Av.D.”) of the multihollow particles is preferably in a range of 10 μm to 100 μm, more preferably in a range of 10 μm to 50 μm and still more preferably in a range of 15 μm to 45 μm. When the average particle diameter exceeds such range, the particles would have a tendency of excessively coming off from the tread and resultantly, wear resistance would tend to be deteriorated. When the average particle diameter falls below the above range, braking performance on ice-covered road would be deteriorated. This is presumably because scratching effect of the particles tends to be decreased. In this application, the average particle diameter is a value obtained by laser diffraction/scattering technique as a volume average particle diameter. In the later-mentioned Examples, the average particle diameter was measured by a Laser Diffraction Particle Size Analyzer “SALD-2200”, a product of Shimadzu Corporation, using red semiconductor laser (wave length of 680 nm) as a light source, and using a dry powder sample.

Reason for large improvement in the braking performance on ice-covered road is currently assumed as follows. A rubber composition for tire tread may be added with lignocellulosic or cellulosic powder for scratching effect, such as powder of walnut shells or the like, and with porous powder for water-absorbing effect such as pulverized bamboo charcoal. When to obtain a certain level or more of the braking performance on ice-covered road by such addition of the lignocellulosic powder and the porous powder, total amount of adding the powder have to be large. And, when the total amount of adding the powder is excessively large, the wear resistance of the tire would be excessively decreased. Resultantly, the amount of adding the powder has to be in a level, at which the ice-covered-road braking performance compromises with the wear resistance. Thus, it is difficult to further improve both of them. On contrary to this, when the multihollow particles having high strength and high porosity are added into a rubber composition for tire tread, the multihollow particles presumably take a role for improving both of the scratching effect and the water-absorbing effect. For example, when 5 mass parts of such multihollow particles are added to 100 mass parts of the diene rubber component, obtained rubber composition would be superior in the performances; to a rubber composition that includes the pulverized bamboo charcoal and the walnut shell powder, by a total addition amount of 5 mass parts, to the 100 mass parts of the diene rubber component.

In embodiments of the invention, 100 mass parts of the diene rubber component is added with the multihollow particles in a range of 0.5 to 20 mass parts, preferably in a range of 0.5 to 10 mass parts, more preferably in a range of 1 to 10 mass parts, and still more preferably in a range of 2 to 8 mass parts. When addition amount is less than 0.5 mass parts, effect of addition would be insufficient; and when the addition amount exceeds 20 mass parts, the wear resistance would be deteriorated.

Preferably, the lignocellulosic or cellulosic powder is added into the rubber composition together with the multihollow particles. Plant body materials as raw materials for obtaining the lignocellulosic or cellulosic powder are those having Moths hardness in a range of 2 to 5, such as seed shells and fruit pits. Adoptable raw materials are pits of fruits such as walnut, apricot, camellia, peach and plum or Japanese apricot, as well as corncobs. Preferably, the lignocellulosic or cellulosic powder is one having been treated with resin liquid of rubber-adhesion improver; in order to improve compatibility with the rubber and to curb excessive coming off of powder particles. An example of such rubber-adhesion improver is a resin liquid mainly comprised of a mixture of a resorcinol-formaldehyde resin prepolymer and latex, which is referred as RFL liquid. Average particle diameter of such resin-treated lignocellulosic or cellulosic powder is preferably in a range of 50 μm to 500 μm, more preferably in a range of 100 μm to 400 μm, still more preferably in a range of 150 μm to 350 μm. Namely, it is particularly preferable to add the resin-treated or not-treated lignocellulosic or cellulosic powder having a relatively large average diameter to the rubber component, along with the above-mentioned multihollow particles that have a relatively small average diameter and are thought to have high adherence onto tread rubber. It is further preferable in improving the braking performance on ice-covered road when a ratio of the lignocellulosic or cellulosic powder, which is especially the powder that is surface-treated with adhesive resin, to the multihollow particles is in a range of 3/7 to 6/4. This is presumably because, by such range of the ratio, a part that continuously exhibits the scratching effect as being firmly adhered to the tire tread is combined with a part that exhibits water absorbing effect as moderately falling off from the tread as to form fine recesses.

The rubber composition according to embodiments of the invention preferably includes a small amount of powder of porous carbonized material that is derived from lignocellulosic or cellulosic material such as wood, bamboo, palm/coconut shell and walnut shell. Among them, pulverized bamboo charcoal is preferable. The pulverized bamboo charcoal has a peculiar porous structure and thus have more excellent absorbability than the multihollow particles or non-carbonized lignocellulosic or cellulosic powder; and hence efficiently absorbs and removes water films that have been generated on ice-covered road surface; so as to increase friction on the road surface and to thereby be able to remarkably increase the braking or other performance on ice-covered road. Partially carbonized powder of lignocellulosic or cellulosic materials, which has carbonized surface part and non-carbonized core part in each particle, may be added to the rubber component in addition with the powder of (fully) carbonized lignocellulosic or cellulosic materials. Such combination is especially preferable because water-absorbing effect based on fine recesses would be further enhanced so as to improve the braking performance on ice-covered road. It is particularly preferred when added to the rubber are all three of: (1) the partially carbonized lignocellulosic or cellulosic powder, (2) the resin-treated lignocellulosic or cellulosic powder and (3) the porous carbonized material. Particle diameter of the powder of porous carbonized material derived from the lignocellulosic or cellulosic material is preferably in a range of 30 μm to 300 μm. Amount of adding the powder of porous carbonized material to 100 mass parts of the rubber component is preferably in a range of 0.5 to 5 mass parts, more preferably in a range of 1 to 4 mass parts.

Further to the above, the rubber composition according to the invention may include various additives that are conventionally used in the rubber composition for tire, such as: carbonblack or silica powder or other reinforcing materials or fillers, process oil, zinc white, stearate, softener, plasticizer, antioxidants (amine-ketone, aromatic secondary amine, phenols and/or imidazole compound or the like), vulcanizing agent, vulcanizing accelerators (guanidine, thiazole, sulfenamide and/or thiuram compound) and the like. Such additives may be included in the rubber composition within an ordinary range, in accordance with a situation given arisen.

When the carbonblack is adopted in the rubber composition for the tread part of the studless tire, it is preferably used the carbonblack that has: a nitrogen-absorption specific surface area (N₂SA; JIS K 6217-2) in a range of 70 to 150 m²/g; and DBP (dibutyl phthalate) absorption (JIS K 6217-4) in a range of 100 to 150 mL/100 g. In detail, adopted carbonblack is of SAF, ISAF or HAF class for example; and amount of its addition is preferably in a range of 10 to 80 mass parts to 100 mass parts of the diene rubber component.

When the silica powder is adopted in the rubber composition, adoptable silica powder is any of: wet-process silica powder, dry-process silica powder, surface-treated silica powder and the like. Amount of addition of the silica powder is preferably no more than 50 mass parts, and total amount of addition of the carbonblack and the silica powder is preferably in a range of 10 to 120 mass parts, to 100 mass parts of the diene rubber component; in view of compromising with tan δ (loss factor in dynamic mechanical analysis) and of reinforcibility and electric conductivity or the like. Preferably, silane coupling agent is added together with the silica powder when and if the silica powder is added into the rubber composition.

The rubber composition according to the invention is obtainable by kneader-mixing with a mixer device such as a Banbury mixer or a kneader device or the like. And, the rubber composition is preferably adopted in the tread part of winter tire such as a studless tire and a snow tire.

The pneumatic tire according to the invention may be formed by preparing the tread part with a rubber extruder or the like from the above rubber composition to form a to-be-vulcanized tire and by subjecting it to a conventional and ordinary vulcanization process. When the tire using the rubber composition is a studless tire having a cap-base structure, it is enough that the rubber composition according to the invention is adopted only to a cap tread part that makes the tread face of the tire.

The pneumatic tire obtained as in the above has adopted the above-mentioned multihollow particles having a high strength and a high porosity. Thus, each of the particles has a high toughness and strength, and hence, scratching effect is achieved; and, at same time, high water-absorbing effect is achieved due to highly porous structure of such micro particles. Consequently, relatively small amount of addition is enough to achieve sufficient extent of the scratching effect and the water-absorbing effect. Moreover, the multihollow particles are able to be formed by acrylic resin or other resin; thus, damage of road surface and/or forming of powder dust of asphalt concrete would be prevented.

### EXAMPLES

Examples according to the invention are given below whereas the invention is no way to be limited to these examples. By use of Banbury mixer, the rubber compositions for the tread of studless tire were prepared in accordance with formulations (expressed in mass parts) shown in Table 1 at below. Details of materials shown in the Table 1 are indicated at below.
Natural rubber: RSS#3;
Butadiene rubber (BR): “BR01”, a product of JSR Corporation (“high cis BR” having cis-1,4 contents of about 95%);
Carbon Black: “SEAST KH”, a product of Tokai Carbon Co., Ltd. (N339 or HAF class);
Silica: “Nipsil AQ”, a product of Tosoh Co., Ltd.;
Silane coupling agent: “Si69”, a product of Evonik Degussa GmbH;
Oil (paraffin oil): “process P200”, a product of JX Nippon Sun-Energy Corporation;
Multihollow particles 1*: “Advancell HB-2051”, a product of Sekisui Chemical Co., Ltd. (average particle diameter is about 20 μm);
Multihollow particles 2*: “Advancell HB-4051”, a product of Sekisui Chemical Co., Ltd. (average particle diameter is about 40 μm); *The multihollow particles 1 and 2 are spherical micro particles of cross-linked acrylic resin and have a porosity of about 50% and the compressive resistance strength of about 30 Mpa. Distribution of microvoids in each particle is uniform throughout from center to a surface layer portion. Diameters of the particles are also uniform.
Multihollow particles 3**: “Technopolymer XX-1696Z”, a product of Sekisui Plastics Co., Ltd. (average particle diameter is about 6 μm); **The “multihollow particles 3” are roughly similar with the multihollow particles of the Advancell HB series. Nevertheless, distribution of microvoids is somewhat less uniform throughout from center to surface layer part.
Hollow particles***: “Matsumoto Microsphere M-600”, a product of Matsumoto Yushi-Seiyaku Co., Ltd.; ***The hollow particles are formed of cross-linked polymer of methylmethacrylate, where each particle has a single large hollow part as to be shaped as a spherical shell. Particle diameters are in a range of 20 μm to 50 μm, and average particle diameter is about 40 μm.
Pulverized bamboo charcoal: A bamboo charcoal powder having average particle diameter of 100 μm, obtained by following. Bamboo charcoal of “Moso” bamboo (Phyllostachys edulis), which is “No. 1 charcoal” of Kabushikikaisha Kyutan, has been pulverized by a hammer mill and graded by sieves;
Resin-treated lignocellulosic powder: Commercially available pulverized walnut shell (“SOFT GRIT #46” of Nippon Walnut Co., Ltd.) is surface-treated with the RFL liquid by a method based on disclosure of JP1998 (H10)-007841A. Average particle diameter of the powder after the treating is about 300 μm.

Each of the rubber compositions of the Examples and Comparative examples has a following common formulation. Namely, to 100 mass parts of the diene rubber component, added are: 2 mass parts of stearic acid (“Lunac S-20”, a product of Kao Corporation), 2 mass parts of zinc white (“Zinc white No. 1”, a product of Mitsui Mining & Smelting Co., Ltd.), 2 mass parts of antioxidant (“Antigen 6C”, a product of Sumitomo Chemical Co., Ltd.), 2 mass parts of wax (“OZOACE0355”, a product of Nippon Seiro Co., Ltd.), 1.5 mass parts of vulcanization accelerator (“Soccinol CZ”, a product of Sumitomo Chemical Co., Ltd.) and 2.1 mass parts of sulfur (“Sulfur powder”, a product of Tsurumi Chemical Industry Co., Ltd.).

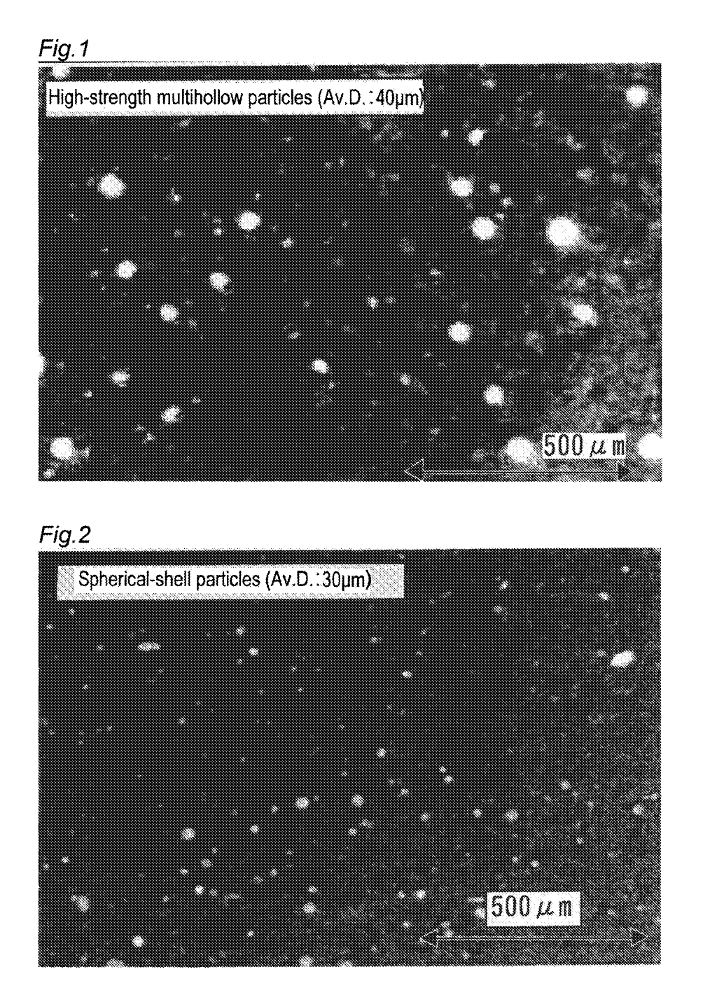

The rubber composition of each of Examples and Comparative examples was used for preparing a studless tire; and wear resistance and braking performance on ice-covered road were evaluated. Adopted tire size was 195/65R15, each of the rubber compositions was used in the tread part of such tire, and vulcanization molding was made by a conventional and ordinary way. Adopted rim size of wheels for testing the tires was 15X5.5JJ. Measurement and evaluation were made as in following.
Hardness at normal and chilling temperatures: Hardness of samples, which had been obtained by vulcanization at 160° C. for 20 minutes and prepared to have thickness no less than 12 mm, was measured by using Durometer Type A in line with JIS K 7215, at 23° C. and at −5° C.
Microstrength (storage modulus E′): Storage modulus E′ at a temperature of −5° C. was measured by a dynamic viscoelasticity-measuring device, a product of Toyo Seiki Seisaku-sho, Ltd., and by: oscillation frequency of 10 Hz, a static strain of 10% and dynamic strain of ±0.25%. Obtained results are expressed as “index” or a ratio by assuming a value of comparative example 1 as 100. The larger the index is, the larger the storage modulus E′ is, and hence, the larger the microstrength is. Namely, lager value of the index means larger strength of the particles incorporated in the rubber.
Tensile stress (M300): In line with JIS K 6251, a tensile test was made by dumbbell No. 3 samples so as to measure a stress at 300% elongation. Obtained results are expressed as “index” or a ratio by assuming a value of comparative example 1 as 100;
E′/M300: Obtained values are expressed as “index” or a ratio by assuming a value of comparative example 1 as 100. Thus, the larger the index is, the larger the flexibility at a macroscopic level and the strength at a microscopic level.
Wear resistance: The tire for testing was mounted on a four-wheel-driving passenger car of 2000 cc displacement, was switched between right-hand and left-hand sides at every 2500 km of travelling distance. After travelling of 10,000 km, depths of four major grooves as remained on the tire were measured, and then, average of them was obtained. Obtained values are expressed as “index” or a ratio by assuming a value of comparative example 1 as 100. The larger the index is, the better the Wear resistance is.
Braking performance on ice-covered road: The tire for testing was mounted on a four-wheel-drive passenger car having 2000 cc engine displacement. The car was run on the ice-floe-covered road of test course, at atmospheric temperature of −3±3° C.; and an anti-lock braking system (ABS) was mobilized at travelling speed of 40 km/h, and then, distance needed for stopping or braking distance was measured. Measurement was made for ten samples (n=10), and then, the average of them was obtained. Obtained values are expressed as “index” or a ratio by assuming a value of comparative example 1 as 100. The larger the index is, the shorter the braking distance is, and hence, the better the braking performance is.
Observation on cut-through surface of vulcanized rubber: 5 mass parts of the “Multihollow particles 2 (Av.D. 40 μm)” or 5 mass parts of the “Hollow particles (Matsumoto Microsphere M-600)” shaped as hollow spherical shells were added to 100 mass parts of the rubber component and mixed with the above-mentioned materials in a Banbury mixer, and then vulcanized to obtain samples corresponding to Example 2 and Comparative example 7 in Table 1. Subsequently, the samples were cut through by a glass knife and obtained cut-through surfaces were observed by a scanning electron microscope (SEM S-3500N, a product of Hitachi, Ltd.). Obtained micrographs are shown in FIGS. 1-2.

Firstly, situation or appearance of the particles in the vulcanized rubber is explained in conjunction with the FIGS. 1-2. FIG. 1 shows the sample having the “Multihollow particles 2 (Av.D. 40 μm)”, which retain original diameters and shapes and show no deformation, no fracture and no chipping. Thus, the particle diameters are kept to be uniform. Meanwhile, FIG. 2 shows the sample having the “Hollow particles (Matsumoto Microsphere M-600)”, which are squeezed and crushed to be variously deformed. Resultantly, diameters and shapes of the particles are extremely heterogeneous.

In following, results of evaluation on tire, which are shown on Table 1, are explained. As compared to comparative examples 2 and 3, in which the pulverized bamboo charcoal or the resin-treated lignocellulosic powder was added and no other porous or hollow particles were added; the braking performance on ice-covered road has remarkably improved, but the wear resistance has been slightly decreased, by Example 1, in which 5 mass parts of the Multihollow particles 1 (Av.D. 20 μm) are added, and by Example 2, in which 5 mass parts of the Multihollow particles 2 (Av.D. 40 μm) are added. When comparison is made between the Examples 1 and 2, no significant difference was observed in the braking performance and the wear resistance. The storage modulus E′ representing the microstrength was larger in Example 2 having larger average diameter of the particles was larger than that of Example 1. On contrary, the tensile stress in Example 2 was smaller than that of Example 1. Nevertheless, values of E′/M300 was remarkably larger in Example 2 than in Example 1. Hence, it would be suggested that the average particle diameter of 40 μm would be more preferable.

TABLE 1

| Formulation | Com. | Com. | Com. | | | Com. | Com. | Com. | Com. | | | | |
|---|---|---|---|---|---|---|---|---|---|---|---|---|---|
| (mass parts) | Ex. 1 | Ex. 2 | Ex. 3 | Ex. 1 | Ex. 2 | Ex. 4 | Ex. 5 | Ex. 6 | Ex. 7 | Ex. 3 | Ex. 4 | Ex. 5 | Ex. 6 |
| NR | 50 | ← | ← | ← | ← | ← | ← | ← | ← | ← | ← | ← | ← |
| BR | 50 | ← | ← | ← | ← | ← | ← | ← | ← | ← | ← | ← | ← |
| Carbon black | 25 | ← | ← | ← | ← | ← | ← | ← | ← | ← | ← | ← | ← |
| Silica powder | 25 | ← | ← | ← | ← | ← | ← | ← | ← | ← | ← | ← | ← |
| Oil | 2.0 | ← | ← | ← | ← | ← | ← | ← | ← | ← | ← | ← | ← |
| Coupling agent | 20 | ← | ← | ← | ← | ← | ← | ← | ← | ← | ← | ← | ← |
| Multihollow | | | | 5 | | | | | | | | | |
| particles 1 (20 μm) | | | | | | | | | | | | | |
| Multihollow | | | | | 5 | 0.1 | 30 | | | 1 | 15 | 5 | 3 |
| particles 2 (40 μm) | | | | | | | | | | | | | |
| Multihollow | | | | | | | | 5 | | | | | |
| particles 3 (6 μm) | | | | | | | | | | | | | |
| Hollow particles | | | | | | | | | 5 | | | | |
| Pulverized | | 5 | | | | | | | | | | | 3 |
| bamboo charcoal | | | | | | | | | | | | | |
| (about 100 μm) | | | | | | | | | | | | | |
| Resin-treated | | | 5 | | | | | | | | | 5 | 3 |
| lignocellulosic | | | | | | | | | | | | | |
| powder | | | | | | | | | | | | | |
| (about 300 μm) | | | | | | | | | | | | | |
| Hardness at 23° C. | 48 | 46 | 47 | 47 | 48 | 48 | 53 | 46 | 48 | 47 | 49 | 48 | 47 |
| Hardness at −5° C. | 51 | 50 | 51 | 50 | 50 | 50 | 55 | 49 | 51 | 50 | 52 | 51 | 52 |
| Microstrength | 100 | 118 | 106 | 120 | 128 | 105 | 163 | 105 | 94 | 114 | 134 | 142 | 145 |
| (Storage modulus | | | | | | | | | | | | | |
| E′) | | | | | | | | | | | | | |
| Tensile stress | 100 | 98 | 125 | 94 | 85 | 99 | 70 | 102 | 110 | 90 | 74 | 100 | 95 |
| (M300) | | | | | | | | | | | | | |
| E′/M300 | 100 | 121 | 85 | 128 | 151 | 106 | 233 | 103 | 85 | 127 | 181 | 142 | 153 |
| Wear resistance | 103 | 100 | 100 | 96 | 94 | 102 | 86 | 108 | 98 | 101 | 90 | 100 | 99 |
| braking | 90 | 100 | 99 | 108 | 110 | 91 | 118 | 92 | 95 | 103 | 113 | 116 | 120 |
| performance on | | | | | | | | | | | | | |
| ice road | | | | | | | | | | | | | |

In Examples 2 to 4, 5 mass parts, 1 mass part and 15 mass parts of the Multihollow particles 2 (Av.D. 40 μm) are respectively added to 100 mass parts of the diene rubber component. As seen from the results, with increase of amount of the particles, the braking performance on ice-covered road was increased. Nevertheless, 15 mass parts of addition caused somewhat large deterioration in the wear resistance. As also seen from the results, the storage modulus of the vulcanized rubber was remarkably increased with increase of the addition amount. This presumably indicates that the particles have never been crushed. The increase of addition amount to 15 mass parts caused remarkable increase in the microstrength and, in same time, remarkable decrease in the tensile stress. This has presumably led to decrease in the wear resistance.

In Example 5, 5 mass parts of the Multihollow particles 2 (Av.D. 40 μm) and 5 mass parts of the pulverized bamboo charcoal are both added. Resultantly, the braking performance on ice-covered road was remarkably increased while maintaining the wear resistance; as compared to Comparative examples 2 and 3, in which only either of the pulverized bamboo charcoal or the resin-treated lignocellulosic powder was added. In Example 5, the storage modulus was larger than that of Example 4 having 15 mass parts of the Multihollow particles 2; and the tensile stress was in a level same with those of the Comparative examples 2 and 3. Such values of the storage modulus and the tensile stresses have been presumed to be related to maintaining of the wear resistance and the braking performance. It is presumed that: the storage modulus was remarkably increased due to filler effect of the Multihollow particles having high strength; and tensile strength was maintained due to effect of the lignocellulosic powder retaining fibrousness and flexibility.

In Example 6, the pulverized bamboo charcoal was further added; and resultantly, the braking performance was slightly increased. Namely, in Example 6, each of the Multihollow particles 2, the pulverized bamboo charcoal and the lignocellulosic powder were added by 3 mass parts, and resultantly, optimum results are achieved. Especially, in Example 6, amount of adding the Multihollow particles having relatively high price was smaller than that of Example 5 while achieving same or higher performances.

In Comparative example 4, in which amount of adding the Multihollow particles was limited to 0.1 mass parts, the wear resistance was maintained but the braking performance on ice-covered road was insufficient. In Comparative example 5, in which amount of adding the Multihollow particles was increased to 30 mass parts, the wear resistance was considerably decreased although the braking performance on ice-covered road was similar with those of Examples 5 and 6.

In Comparative example 6, the Multihollow particles 3 having average diameter of 6 μm is added by 5 mass parts. Resultantly, although the wear resistance was increased, the braking performance on ice-covered road was insufficient. This is presumably because the particle size was too small and hence the scratching effect was insufficient. In Comparative example 7, 5 mass parts of the Hollow particles (spherical-shell polymer particles) having 20-40 μm diameter was added; and resultantly, the braking performance on ice-covered road was insufficient while the wear resistance was mostly maintained. It is suggested that particle strength was not enough because the storage modulus was small. And, this presumption consists with a result in an electron micrograph of FIG. 2. It is presumed that insufficient particle strength led to not only insufficient scratching effect but also decrease of water-absorbing effect due to crushing of the particles.

The rubber composition according to the invention may be used in pneumatic tire including winter tires such as a studless tire and a snow tire, and tires for industrial vehicles, as well as a rubber product requiring anti-skid performance, such as a shoe sole, a mat or carpet, and flooring materials.

What is claimed is:

1. A rubber composition for tire comprising:
diene rubber component consisting of diene rubber polymer(s); and
multihollow particles amounting 0.3-20 mass parts relative to 100 mass parts of the diene rubber component; and
microvoids being distributed in each of the multihollow particles throughout from a vicinity of center portion to a vicinity of surface of the particle; and porosity of the multihollow particles being in a range of 40% to 60%.

2. The rubber composition according to claim 1, further comprising a lignocellulosic powder, surface of which has been treated with resin liquid for improving adhesion with rubber material, and/or powder of porous carbonized material that is derived from lignocellulosic or cellulosic material.

3. A pneumatic tire that has a tread part having been formed of the rubber composition according to claim 1.

4. A pneumatic tire that has a tread part having been formed of the rubber composition according to claim 2.
